(19) United States
(12) Patent Application Publication
(10) Pub. No.: US 2006/0202373 A1
(43) Pub. Date: Sep. 14, 2006

(54) Thermoplastic granulates

(76) Inventors: Norbert Guntherberg, Speyer (DE); Bernhard Czauderna, Hirschberg (DE); Michael Sauer, Hockenheim (DE); Rainer Bardon, Dannstadt-Schauernheim (DE); Yohwan An, Ulsan City (KR)

Correspondence Address: CONNOLLY BOVE LODGE & HUTZ, LLP, P O BOX 2207, WILMINGTON, DE, 19899, US

(21) Appl. No.: 10/549,098

(22) PCT Filed: Mar. 10, 2004
(86) PCT No.: PCT/EP04/02433

§ 371 Date: Sep. 13, 2005

(30) Foreign Application Priority Data
Mar. 13, 2003 (DE) 103 10 829.7

(51) Int. Cl. B29B 9/06

(52) U.S. Cl. 264/142; 264/408

(57) ABSTRACT

Pelletized materials based on at least one thermoplastically processable polymer, where the pellets have less than 10% of concave regions and otherwise are convex in every other region, this being determined by means of incident-light interference-contrast spectroscopy, by taking the average value for the ratios of the outline area to the entire outline area for an assembly of pellets.

The present invention relates to pelletized material based on at least one thermo-plastically processable polymer, where the pellets have less than 10% of concave regions and otherwise are convex in every other region, this being determined by means of incident-light interference-contrast spectroscopy, by taking the average value for the ratios of the outline area to the entire outline area for an assembly of pellets. The present invention further relates to a process for producing these pelletized materials. The invention also relates to the use of these pelletized materials for producing moldings, films, or fibers. Finally, the invention relates to the moldings, fibers, or films obtainable from these pelletized materials, and to a method for the quality control of pelletized materials. Other embodiments of the present invention are given in the claims, description, and examples. The abovementioned individual features of the inventive process, and those which will be described hereinafter, may, of course, be used not only in the respective stated combination but also in other combinations, while remaining within the scope of the invention.

It is frequently difficult to achieve uniform coloring of synthetic-resin-based moldings, especially if they are large. It is also often difficult to match the color of one molding to that of a second molding. The reason for the considerable difficulty encountered in obtaining synthetic-resin-based moldings with few or no regions of more intense coloring and few or no regions of less intense coloring is that there are so many factors which can make the final coloring non-uniform. Examples of factors which play a part are the nature of the pigment, the nature of the plastic, and the nature and manner of mechanical mixing.

It is an object of the present invention to deal with the problem of uniform coloring of moldings. We have found that this object is achieved by using the synthetic-resin-based pelletized materials defined at the outset to produce moldings with very precise and homogeneous coloring. Another object was to find a process which can give these pelletized materials. A further object of the present invention was to find a method which can distinguish between the pelletized materials capable of processing to give moldings with good coloring and pelletized materials which are more difficult to color.

There are known processes for underwater pelletization of fusible polymers. In these, the molten polymer is, for example, extruded through a die, and the melt stream is divided into small pieces by a rotating knife in the presence of water. During this procedure, and thereafter, the resultant particles cool. The outer layer here cools first, and the interior then hardens. The cooling procedure progresses from the outside to the inside. A reduced pressure can therefore arise in the interior of the particle during cooling. The result can be that the outer layer is drawn inward, and a cavity or vacuole can form in the interior of the particle. The cavity can fill with gas or moisture during storage of the particles (WO 96/26241). To avoid cavitation, WO 96/26241 proposes, prior to the cutting process, bringing the polymer melt extrudate into contact with water whose temperature is at least 44° C., and then pelletizing the extrudate. As disclosed in WO 96/26241, if vacuoles are present in the pelletized materials, silver streaks and bubbles arise on the surface during processing to give moldings. WO 96/26241 says nothing about the problem of production of uniformly colored moldings.

WO 99/52967 discloses an underwater pelletization process which can give pelletized materials with less than 10% by volume of vacuoles. According to that specification, the vacuoles disrupt further processing of the pelletized materials, and the pelletized materials themselves are visually unattractive. In this process, the extruded polymers are cooled at a cooling rate of less than 50° C./s to a temperature which is above the glass transition temperature T_{g} of the polymer by from 1 to 20° C. The polymers are then cut. During the cutting process, the polymers are preferably cooled to below 100° C., and the extent to which the coolant is cooler than the polymer here is intended to be not more than 370° C. To this end, the polymer extrudate may be sprayed with water, the temperature of which should, according to the Description, be from below 30 to 80° C. Another method of cooling the polymer passes it through a water bath for a period of from 3 to 10s, the bath temperature being from 40 to 80° C. That publication says nothing about the problem of obtaining uniformly colored moldings, nor does it disclose any process which could produce pellets with few depressions.

U.S. Pat. No. 4,385,016 discloses a process capable of underwater pelletization and transport in w particular of pelletized materials in which gas inclusions, specifically blowing agents, are present. Mention is made of the fact that uniform pelletized materials can be obtained. According to the Description, the pelletizing head is flushed with water whose temperature is from 83 to 100° C., and the particles are cooled in the water bath to a temperature of from 66 to 100° C., and transported by water whose temperature is 94° C.

It has also been disclosed that resins comprising blowing agent can be pelletized at increased or reduced pressures, in order to give precise control of the foaming process (DE-A 198 19 058; U.S. Pat. No. 5,234,963).

In JP-A 11-179724, underwater pelletization produces poor configuration of pelletized material as a result of die blockage. According to the specification, this can be avoided if the water in the cutting chamber has a temperature of more than 80° C., but does not boil. To avoid this, pelletization may be carried out at an increased pressure. According to the Description, the water introduced to the cutting chamber has a temperature of from 40 to 70° C.

In the context of the object of the invention, it has been found that pellets with a minimum number of depressions give very good processing to give finished parts which have very uniform colorant distribution. For reasons of process technology, preference is given to pellets which have a low proportion of depressions and also a low proportion of vacuoles.

For the purposes of the present invention, pellets are small particles. The size of the pellets can be selected freely, but generally depends on practical considerations. Pellets which are either very small or very large are often difficult to handle during packing or further processing. For example, they are difficult to introduce into the processing machine, or are difficult to meter. The pellets may be elongate to round. Preference is given to pellets whose longest axis is in the range from 0.5 to 10 mm, preferably in the range from 0.8 to 5 mm, and whose shortest axis is in the range from 0.2 to 5 mm, preferably in the range from 0.5 to 5 mm. For many applications, preference is given to pellets which are round or almost round, i.e. whose aspect ratio (ratio of longest to shortest axis) is in the range from 3.5 to 1, preferably in the range from 2 to 1. An example of a method of influencing the size and the shape of the pellets uses the size of the die through which the polymer melt is extruded, but these can also be influenced by the throughput, the viscosity of the polymer melt, and the rate at which this is comminuted. Measures of this type are known to the person skilled in the art, or may be undertaken by such a person using methods known per se (e.g. Granulieren von Thermoplasten: Systeme im Vergleich, Jahrestagung Aufbereitungstechnik, Baden-Baden, 24/25, 11. 99, VDI Verlag pp. 327-401).

The outline area of pellets of the invention has, based on the entire outline area of an assembly of pellets, less than 10%, preferably less than 8%, in particular less than 5%, of concave regions. Particular preference is given to defect-free pellets, but even those pellets whose outline area has, based on the entire outline area, for example from 1 to 3%, or from 1 to 2%, of concave regions can be processed to give very uniformly colored moldings.

According to the invention, the proportion of concave regions is determined by incident-light interference-contrast spectroscopy. For this, a defined number of pellets, i.e. an assembly, is studied.

The number of pellets in the respective assembly is selected to permit statistical evaluation. The minimum number is 10 pellets. The pellets are secured to a glass slide, and to this end a surface is provided with an adhesive. The pellets are inspected under incident polarized light (between crossed (90°) polarizers) under an optical microscope (for example a Zeiss Axiophot). The magnification is selected so that each image precisely corresponds to the entire pellet. The reflections from pellets with no concave regions take the form of points or lines. The reflections from pellets with concave regions are annular. To characterize the reflections, the annular reflection is traced in the digitized image with the aid of image-analysis software (e.g. analySIS). The enclosed area associated with the outline is determined, ignoring the curvature of the surface of the pellet. This area is termed the outline area. The outline of the part of the pellet surface visible under the microscope is also traced. Again, the enclosed area associated with the outline is determined, ignoring the curvature of the surface of the pellet. This area is termed the entire outline area. The ratio of the outline area to the entire outline area [%] is a measure of the size of the concave region. Each member of the assembly is subjected to these measurements, and the arithmetic mean of the ratio is determined for the assembly.

The pelletized materials of this invention therefore have a substantially smooth surface, and this means that they have substantially no depressions. This implies that the curvature of the pellet is convex at every region of its surface, or at least over substantial proportions of its surface. A depression is any indentation in the direction of the interior of the pellet. A depression here may be a slight indentation, or else a very deep indentation, or a hole.

In the pelletized materials which are preferred according to the invention, less than 10%, preferably less than 8%, in particular less than 5%, of the pellets, based on the total number in an assembly of pellets, have vacuoles. Particular preference is given to defect-free pellets, but even those pelletized materials in which the proportion of pellets having vacuoles is, for example, from 1 to 3%, based on the total number in an assembly of pellets, can be processed to give very good colored moldings. A vacuole is that part of the volume delimited by the surface of the pellet which is occupied neither by the polymer composition nor by any other solid, nor by a liquid, i.e. a sealed, inaccessible cavity. Pellets in which a vacuole is present may at the same time also have a small concave region at the region where the vacuole has formed. However, pellets in which a vacuole is present may also have a defect-free surface.

The prior-art method of analysis by separation in sodium chloride solution does not give unambiguous and reproducible results, and according to the invention, therefore, the proportion of vacuole is determined using analysis by separation in a water/deuterium oxide mixture. For this, a test plaque is injection-molded from the pelletized materials in a first step, and this is used to determine the density of the material to be studied. As an alternative, the density may also be determined to ISO 1183. A mixture is then prepared from D₂O and H₂O, its density being about 1% below the density of the material. The compact material slowly sinks in this mixture. 10 g of a specimen of pelletized material (selection, see above) are then stirred vigorously for a period of 5 minutes in 100 g of the mixture of D₂O and H₂O, treated with 1 g of K30 surfactant (a mixture of mainly secondary sodium alkylsulfonates of average chain length C15) from Bayer AG. Pellets in which vacuoles are present float, whereas the remaining pellets sink. The test is repeated three times, and the arithmetic mean of the number of floating pellets is determined, based on the average total number of pellets studied.

The pelletized materials of the invention generally also have a residual moisture level of less than 0.5%, preferably less than 0.3%, in particular in the range from 0.01 to 0.15% by weight, based on the total weight of an assembly. The residual moisture level is determined by gravimetric drying. For this, a defined amount (e.g. 1 or 10 g) of pelletized material is weighed out, and dried for a period of 20 min at a defined temperature, which for SAN is 160° C. The percentage weight loss corresponds to the residual moisture content.

In principle, any of the thermoplastically processable polymers may be used as polymers from which the pelletized materials of the invention may be produced. Preference is given to polymers whose softening point (Vicat softening point with a force of 50 N and a temperature rise of 50 K/h, VST/B/50 to ISO 306) is in the range from 60 to 250° C., preferably in the range from 80 to 180° C., and whose melt can be processed at temperatures in the range from 150 to 350° C., preferably from 180 to 320° C., in particular from 200 to 300° C. Examples of these may come from the class of the polyacetals, polyacrylates, polycarbonates, polyamides, polyesters, polymethacrylates, polyolefins, polyphenylene ethers, polystyrenes, styrene copolymers, polyurethanes, polyvinyl acetates, polyvinyl chlorides, or polyvinyl ethers. It is also possible to use a mixture of two or more different polymers.

Preference is given to pelletized materials based on styrene copolymers, e.g. styreneacrylonitrile copolymers, often also termed SAN copolymers, acrylonitrile-butadienestyrene copolymers, often also termed ABS, acrylonitrile-acrylate-styrene copolymers, often also termed ASA. According to the invention, this list also includes derivatives or variants of SAN copolymers, ABS, and ASA, for example those based on alphamethylstyrene or methacrylate, or those which encompass other comonomers, an example being the material known as MABS. Mixtures of two or more different styrene copolymers may, of course, also be used. Styrene copolymers are known to the person skilled in the art, or may be prepared by methods known per se. Preference is also given to mixtures of the styrene copolymers mentioned with polyamides, with polybutylene terephthalates, and/or with polycarbonates.

The polymers may be used as they stand. However, they may also comprise additives, such as lubricants, mold-release agents, waxes, flame retardants, antioxidants, light stabilizers, or antistatic agents. The polymers preferably comprise no fibrous or pulverulent reinforcing agents. They moreover particularly preferably comprise no colorants, such as pigments or dyes.

The pelletized materials of this invention may be produced by a multistage process. First, the thermoplastic polymer to be pelletized is melted in a plastifying unit. Kneaders are preferably used for this purpose. In particular, use may be made of extruders, such as single- or twin-screw machines. In one of the preferred embodiments, the process of the invention uses extruders which are also equipped to dewater the polymers in which aqueous moisture is present, for example those coming directly from the preparation process. Extruders preferred among these are those where the residual water is discharged at least to some extent in liquid form from the extruder. Particular preference is given to the use of extruders of this type when pelletized materials based on styrene copolymers or blends which comprise styrene copolymers, in particular ABS, ASA, or MABS, are to be produced. These extruders are known, and are described by way of example in EP A1 734 825.

In a first step of the process, the polymer melt is extruded through a die. An example of a die used is a pelletizing die, for example a circular-arrangement pelletizing die. Pelletizing dies which may generally be used are heated pelletizing dies, such as those with mandrel/peripheral heating, those of heating-channel type, or those of heat-exchanger type. Among these, preference is given to heated-channel types and heat-exchanger types.

According to the invention, the polymer melt is extruded into a cutting chamber flooded with a liquid coolant. The cutting chamber surrounds the die, e.g. the pelletizing die and the apparatus used to comminute the polymer melt. The size and shape of the cutting chamber may in principle be freely selected, and depends on practical considerations, such as the size of the pelletizing die, the geometry of the knives, the amount of coolant to be transported through the cutting chamber, or the throughput of polymer.

Water is mostly used as coolant. In principle, use may be made of any water which is optically clear, e.g. filtered river water or well water. It is preferable to use demineralized water. The conductivities of the demineralized water used are generally less than 20 μS/cm, preferably less than 12 μS/cm, determined to DIN EN 27888 in combination with DIN 50930-6.

However, use may also be made of other coolants, such as mono- or polyhydric alcohols, e.g. glycol, or paraffins.

In one preferred embodiment, the coolant is used at atmospheric pressure. The temperature of the coolant here is generally from 60 to 95° C. The temperature of the coolant is preferably in the range from 70 to 95° C., in particular in the range from 80 to 95° C., for example in the range from 80 to 90° C. However, in another preferred embodiment, the coolant may also be used under increased pressure. For example, the coolant may be used at up to 130° C., for example at an elevated pressure and at a temperature in the range from 60 to 130° C., preferably from 70 to 100° C., in particular from 80 to 98° C.

It can therefore be preferable for the pressure to be up to 6 bar, e.g. from 1 to 5 bar. For example, the pressure may be in the range from 1 to 4 bar, preferably from 1 to 3 bar, in particular from 1 to 2 bar. In one of the preferred embodiments, the coolant in the cutting chamber is subject to a pressure of at least 1.1 bar. This is particularly preferable when, for example, the coolant has a low boiling point, for example when water is used as coolant, and the intention is to operate with a coolant temperature above 100° C.

In a second step, the polymer melt is comminuted. For this, cutting apparatus such as rotating knives may be provided. Use is preferably made here of multi-arm rotating knives. For example, use is made of knife heads having 6, 8, 12, 14, or more, for example up to 50, rotating knives (and the number of knives here does not necessarily have to be an even number). The arrangement of these is generally such that they rotate in the cutting chamber in front of the die, e.g. the heated die plate. Examples of the rotation rates are in the range from 300 to 5 000 rotations per minute. The setting of the knives may be undertaken manually, pneumatically, or hydraulically, or take place automatically by way of force exerted by springs. These measures are known to the person skilled in the art.

Very short periods generally elapse between discharge of the polymer melt and comminution of the same. According to the invention, these are not more than 20 ms, preferably not more than 10 ms, in particular not more than 5 ms. Since the temperature of the polymer melt on its discharge from the die is generally in the range from 150 to 350° C., preferably from 180 to 320° C., in particular from 200 to 300° C., the extent to which the temperature of the polymer melt during cutting is below the discharge temperature is generally not more than from 10 to 20° C.

According to the invention, the pellets obtained in the second step are cooled in a third step. The preferred cooling rate here depends on the nature of the polymer. According to the invention, the cooling rate is from 2 to 30° C./s, preferably in the range from 5 to 20° C./s, in particular in the range from 8 to 15° C./s. During the cooling step, the ratio by volume of pellets to coolant is generally from 0.03:1 to 0.12:1, preferably from 0.06:1 to 0.1:1. It is generally preferable for the external temperature of the pellets after the third step to be from 100 to 200° C., preferably from 100 to 150° C. This temperature is determined by taking a defined amount of specimen material, removing the adherent coolant, and using an IR chamber to measure the temperature.

It is preferable that the coolant used to cool the pelletized material is the same as that into which the polymer melt is extruded and in which it is comminuted. The third step of the process preferably takes place outside the flooded cutting chamber.

While the pelletized materials are being cooled, they are preferably simultaneously transported to a drying apparatus. Heat may be removed from the cooling medium here throughout the entire transport section. However, it is also possible for heat to be removed from the cooling medium only in parts of the transport section. In one particularly preferred embodiment, no heat is removed from the cooling medium in a first part of the transport section, and heat is removed from the cooling medium in a second part. The length of the first part may be up to 80% of that of the entire transport section, and its length may, for example, be up to three quarters of that of the entire transport section.

An example of a method of drying the pelletized materials uses the conventional drying apparatus described in the technical literature. Examples of suitable drying apparatus are centrifugal driers and fluidized-bed driers (loc. cit. pp. 333-336). Particular preference is given to drying apparatus in which concomitant use can be made of the residual heat present in the pelletized material after the third step, to promote the drying procedure.

The resultant pelletized materials of the invention are suitable for producing moldings, films, or fibers which comprise colorants. In particular, the pellets are suitable for producing large-surface-area, uniformly colored moldings, or uniformly colored films. The pelletized materials of the invention are particularly suitable for mixing with colorants, such as color pigments, by applying these to the surfaces of the pelletized materials, where appropriate together with adhesion promoters, and then using injection-molding apparatus without particular additional mixing apparatus to melt the resultant pellets surface-coated with the colorants, and inject the material into molds. The pelletized materials of the invention may also be used to produce colored moldings or films, the color of which has been matched to a second, separately produced molding, or to a second, separately produced film. In addition, it is very much easier to reproduce the color of a master sample, e.g. of a sample plaque, in a molding or in a film. Due to the even surface, colorants can be incorporated very uniformly into the pelletized materials. The moldings, films, or fibers obtainable from the pelletized materials of the invention have substantially homogeneous coloring, and this means that the color difference, determined as color difference ΔE (in accordance with the CIELAB formula, DIN 6174, D65, 10° standard observer) is small. The absolute color locus, i.e. whether the color is pale or dark, determines whether any actual color difference is detected. Moldings, films, or fibers of the invention which are, for example, white-colored, preferably have ΔE values of less than 0.3, in particular less than 0.2. By way of example, dark-brown-colored moldings, films, or fibers preferably have ΔE values of less than 0.5, preferably less than 0.3.

Furthermore, the phenomenon known as “silver streaks” is absent in moldings produced from the pelletized materials. In addition, the surface of the moldings produced from the pelletized materials of the invention is substantially free from bubbles.

### EXAMPLES

Determination of Proportion of Concave Regions:

The proportion of concave regions was determined both visually and by incident-light interference-contrast microscopy. For this, a defined number of pellets, i.e. an assembly, was studied. The procedure here in the selection of the assembly was that three specimens of the same weight were taken from the stream of pellets at three different junctures, the three specimens were intimately mixed, and the assembly to be tested was taken from this mixture.

The number of pellets was respectively 10, 50, or 100. The flat side of the pellets was secured to a glass slide. The pellets were inspected under incident polarized light (between crossed (90°) polarizers) under an optical microscope (a Zeiss Axiophot). The magnification was selected so that each image precisely corresponded to the entire pellet. The reflections from pellets with no concave regions took the form of points or lines. The reflections from pellets with concave regions were annular. To characterize the reflections, the annular reflection was traced in the digitized image with the aid of image-analysis software (analysiS). The enclosed area associated with the outline (i.e. associated with the annular reflection) was determined (outline area), ignoring the curvature of the surface of the pellet. The outline of the part of the pellet surface visible under the microscope was also traced. Again, the enclosed area associated with the outline was determined (entire outline area), ignoring the curvature of the surface of the pellet. The ratio of the outline area to the entire outline area [%] is a measure of the size of the concave region. Each member of the assembly was subjected to these measurements, and the statistical average of the ratio was determined for the assembly.

Determination of Proportion of Vacuoles:

Analysis by separation in water/deuterium oxide mixture. For this, a test plaque was injection-molded from the pelletized materials in a first step, and this was used to determine the density of the material to be studied. A mixture was then prepared from D₂O and H₂O, its density being below the density of the material. The compact material slowly sank in this mixture. 10 g of a specimen of pelletized material were then stirred vigorously for a period of 5 minutes in 100 g of the mixture of D₂O and H₂O, treated with 1 g of K30 surfactant (a mixture of mainly secondary sodium alkylsulfonates of average chain length C15 from Bayer AG). Pellets in which vacuoles were present floated, whereas the remaining pellets sank. The test was repeated three times, and the mean of the number of floating pellets was determined, based on the average total number of pellets studied.

FIG. 1: Image of a pellet of the invention with reflection taking the form of a line

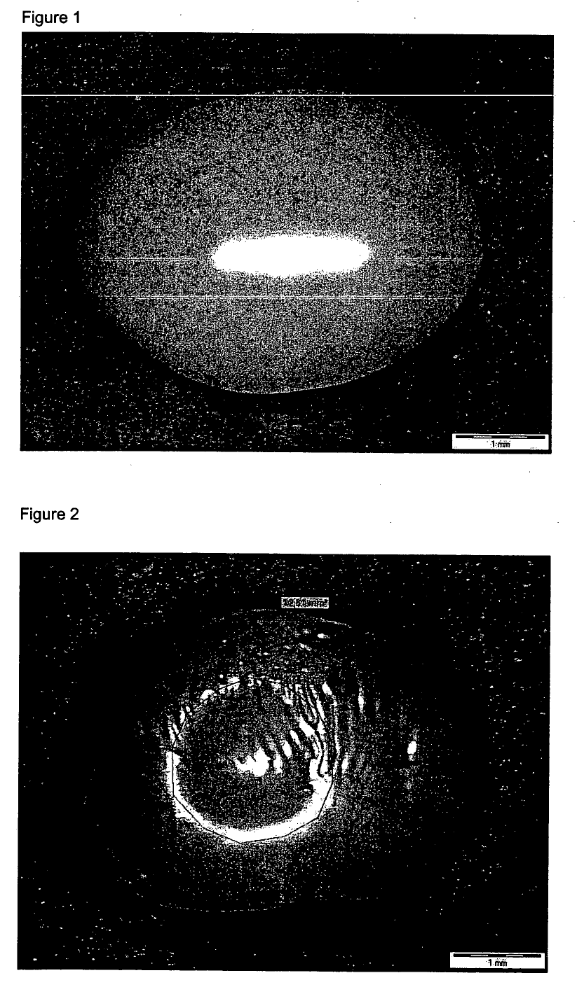

FIG. 2: Image of a pellet with concave region

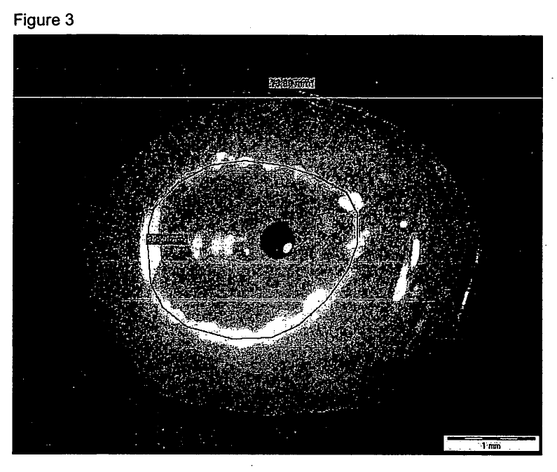

FIG. 3: Image of a pellet with concave region and vacuole

### Inventive Example 1 and Comparative Examples 1C and 2C

An ABS with about 30% by weight rubber content was pelletized in a water-flooded cutting chamber.

The temperature of the melt was about 250° C. The cutting apparatus had 10 blades, and its rotation rate was 3000 rpm. The other conditions, and the results, are found in table 1.

TABLE 1

| | | | | | Number^{d)} |
|---|---|---|---|---|---|
| | | | | | of |
| | | | | | depressions |
| | | | Pressure^{c)} | Appearance | per 50 |
| Example | Vₚ:V_{w}^{a)} | T_{w}[° C.]^{b)} | [bar] | of pellets | pellets |
| 1C | 0.06 | 75 | 1 | Depression + | n.d. |
| | | | | vacuoles | |
| 2C | 0.08 | 82 | 1 | Depressions | 45 ± 1.5 |
| 1 | 0.093 | 95 | 1.8 | Substantially | 1 ± 1 |
| | | | | defect-free | |

^{a)}Polymer/water volume ratio in cutting chamber and transport section
^{b)}Water temperature in cutting chamber
^{c)}Pressure in cutting chamber
^{d)}The number of depressions was determined by counting. For this, a specimen of 50 pellets was secured to a substrate and evaluated by three people, using 10× magnification.
n.d.: not determined

Quantitative determination of depressions for comparative example 2C.

Incident-light interference spectroscopy was used to test a specimen of 10 pellets. The following values were obtained:

| | | Depression as % of total |
|---|---|---|
| Pellet area [mm²] | Depression area [mm²] | area |
| 13.90 | 3.81 | 27.4 |
| 12.56 | 3.68 | 29.3 |
| 13.45 | 3.39 | 25.2 |
| 13.22 | 2.99 | 22.6 |
| 12.61 | 1.52 | 12.1 |
| 11.88 | 3.35 | 28.2 |
| 11.00 | 2.89 | 26.3 |
| 12.00 | 1.21 | 10.1 |
| 14.48 | 4.15 | 28.7 |
| 12.84 | 2.98 | 23.2 |

The average value for depressions as % of total area was 23.3±6.8.

### Inventive Example 1

Incident-light interference spectroscopy was used to test a specimen of 10 pellets.

Of the 10 pellets, 9 gave reflections entirely in the form of points or lines. The outline area of the pellet with depression was 12.95 mm². The outline area of the depression was 1.14 mm². The ratio of the outline area to the entire outline area was thus 8.8%.

### Inventive Example 2

A copolymer with 30% by weight acrylonitrile content and 70% by weight amethylstyrene content was pelletized under the conditions used for example 1. The resultant pellets were of uniform shape and had a smooth surface without depressions and vacuoles. The density was 1.0825±0005 g/cm³, and the residual moisture level was about 0.1%.

The result of analysis by separation was that 49 of 50 pellets sank.

### Comparative Example 3C

The copolymer was the same as that used for example 2, and was pelletized under the conditions used for comparative example 1C, but with T_{w}=70° C. The proportion of outline area for the pellets was from 10 to 30%. The density was 1.0378±0.02 g/cm³. The residual moisture was about 0.7%. The analysis by separation was carried out using a varying number of pellets. The results are found in table 2.

TABLE 2

| Number of | Number | | |
|---|---|---|---|
| pellets | floating | Number sinking | % of vacuole-free pellets |
| 79 | 64 | 15 | 81 |
| 50 | 41 | 9 | 82 |
| 30 | 22 | 8 | 73 |

1-3. (canceled)

4. A process for producing pelletized materials based on at least one thermo-plastically processable polymer, where the pellets have less than 10% of concave regions and otherwise are convex in every other region, this being determined by means of incident-light interference-contrast spectroscopy, by taking the average value for the ratios of the outline area to the entire outline area for an assembly of pellets, which comprises the following steps:
extruding the polymer melt through a die into a cutting chamber flooded with a coolant,
comminuting the polymer melt, the interval between the juncture of discharge of the polymer melt from the die and the comminution to give pellets being less than 20 ms, and
cooling the resultant pellets in a liquid coolant at a temperature in the range from 60 to 130° C., using a cooling rate of from 2 to 30° C./s.

5. A process as claimed in claim 4, wherein the ratio by volume of pellets to coolant in the cooling phase is in the range from 0.03:1 to 0.12:1.

6. A process as claimed in claim 4, wherein the coolant in the cutting chamber is subject to a pressure of at least 1.1 bar.

7.-8. (canceled)

9. A method for the quality control of pelletized materials via incident-light interference-contrast spectroscopy, which comprises determining the enclosed area associated with the outline of the annular reflections produced by concave regions in the surface of the pellet, and calculating the ratio of this to the enclosed area associated with the outline of the entire inspected, ignoring the curvature of the surface of the pellet.

10. A process as claimed in claim 5, wherein the coolant in the cutting chamber is subject to a pressure of at least 1.1 bar.
